(19) United States
(12) Patent Application Publication
(10) Pub. No.: US 2004/0014469 A1
(43) Pub. Date: Jan. 22, 2004

(54) Method and device or re-using information received previously in a telecommunication network such as the internet

(76) Inventor: Luigi Lancieri, Evrecy (FR)

Correspondence Address: Gerald E Helget, Briggs & Morgan, 2400 IDS Center, 80 South Eighth Street, Minneapolis, MN, 55402, US

(21) Appl. No.: 10/399,370

(22) PCT Filed: Oct. 16, 2001
(86) PCT No.: PCT/FR01/03196

(30) Foreign Application Priority Data
Oct. 17, 2000 (FR) 00/13419

(51) Int. Cl. H04Q 7/20

(52) U.S. Cl. 455/422.1; 455/445

(57) ABSTRACT

This invention concerns a method and a device for reusing information previously received by a receiving entity associated with an intermediate storage means (10), in a telecommunication network such as the Internet. Said intermediate means of storage (10), a proxy cache, for example, is capable of temporarily storing information making up objects transmitted to said receiving entity following successive requests from said receiving entity. Said process comprises a stage consisting in copying all the objects contained in said intermediate means of storage (10) that satisfy preset criteria, and a step consisting in storing, with appropriate indexing, the copies made of said objects in an object management means (30), a Web server, for example, associated with said receiving entity.

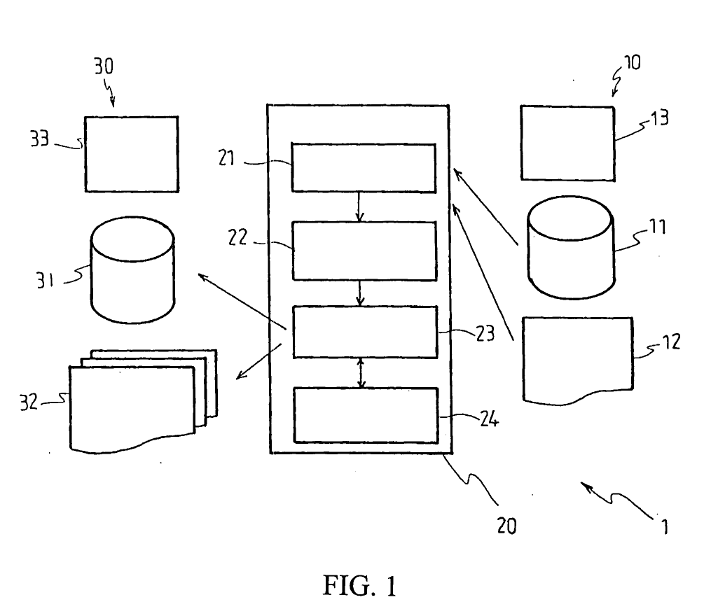

More particularly, only objects that are bigger than a preset size are copied.

This invention regards a method and a device for reusing information received previously by a receiving entity in a telecommunication network, particularly the Internet. By receiving entity, we mean a local element of the telecommunication network through which users can access information contained in the telecommunication network. For example, when the telecommunication network is the Internet, this may involve a local computer network hosting a corporate site.

In a telecommunication network like the Internet, information is available at sites distributed over the network and is accessible from any access point such as a user terminal. A distributed information system like the World Wide Web provides users access to distributed sets of composite multimedia documents connected to one another by hypertext links. The Web sites and documents, identified by addresses called URLs (Uniform Resource Locators) are accessible and viewable thanks to software called browsers. Other information systems exist. In individual fashion targeted by the user [sic]. An object may be made up of files such as general files; we will call a set of data forming HTML (for Hypertext mark-up Language) page content of images, sounds, etc., an object. The term link will designate the means of accessing an object. This may, for example, be a hypertext link.

A common type of access to the information is through a server. One function of a server is to deliver, at the user's request, an item of information effectively contained in a set of information with which it is associated. The server allows a user to access information contained, for example, in a remote local network. For example, a Web server receives an HTTP access request message for an object emitted by the user terminal and in return transmits the object requested in the form of a message. The term HTTP (for Hyper Text Transfer Protocol) designates a well-known access protocol for a Web URL address.

A first problem to be solved in this technical domain concerns the speed of access to the data. On the Internet, the transmission of messages is faced with traffic volume problems that limit the data transmission speed and increase wait times.

One solution for reducing this problem consists in using so-called proxy caches installed on the servers in order to assist the originating servers that manage the objects they disseminate. This well known type of device will be designated by the term proxy cache. When an HTTP request message to access an object is sent by a user terminal, an associated proxy cache can return the object directly if it is contained in the cache as the result of an identical prior request. Otherwise, an HTTP request message is sent from the proxy cache to the originating server hosting the URL for transmission of the object to the user. Concomitantly, the proxy cache indexes and stores the object. One of the advantages of the cache is that it brings the information and the user closer together. The use of a proxy cache translates into a savings in response time and ultimately into a cost savings if the transfer from the originating server has a certain cost.

Another solution to the problem of the speed of access to the data consists in reproducing the content of the originating server in other servers called mirrors. A concentration of connections on the originating server is thus avoided.

Another problem to be solved in this technical domain concerns the selectivity of access to the data, involving automatic assistance for the user making it possible to refine his information search.

Search engines are well known devices that allow a user to search for information located on the Web. They provide the user with pointers toward these contents.

The different devices and methods that have just been cited do not, individually, offer any solution to the two problems of data access speed and data access selectivity and also present other problems.

The cache only keeps the objects for a determined amount of time controlled by an algorithm that is a function, for example, of the input date, the size, and the access history. Often, caches are configured to store only objects that are not too big. In principle, if an object is not requested again quickly, it is eliminated from the cache to create space for more recent objects. In the example of a proxy cache associated with a corporate site, the average use life of a document is only a few days, unless it is requested quite often. The cache is a component whose behavior is probabilistic and, as a consequence, it is difficult to control the nature and the use life of its content.

Contrary to caches, the content of mirrors is determined. The administrator must take the initiative to copy the information, which means that he controls all the parameters tied to the content such as the life span, the quantity copied, the location, etc. The management of mirror sites is often systematic. It generally involves identical organizations of contents. In other words, this type of system has no autonomy with respect to the constitution of the content accessible by the end user.

Search engines only provide pointers toward information. They therefore require a connection to the originating server to retrieve the information.

A known system, CDN (for Content Delivery Network), is an improved version of mirrors and it mitigates a certain number of their deficiencies. It is based on a distributed architecture of storage components like mirrors or caches. It aims to combine certain advantages of caches and mirrors. Copying the information from the originating server to the storage components can be done with a certain autonomy. On the other hand, this autonomy does not exist for establishing the content: the CDN system merely replicates the organization and the contents of the originating servers.

In certain previous devices and methods, the copying operation is done manually. When the copy is not made at the initiative of the possessor of the information, this possessor has no feedback regarding the number of accesses. This is a serious disadvantage if the possessor of the information is remunerated based on the number of accesses.

The object of this invention is to propose a system, to be added to the range of existing solutions, to improve the speed and the selectivity of access to the data in a telecommunication network that would make it possible to overcome the problems cited previously.

To this end, it proposes a method for reusing information previously received by a receiving entity with which is associated an intermediate means of storage in a telecommunication network, said intermediate means of storage being designed to temporarily store information constituting objects transmitted to said receiving entity following successive requests from said receiving entity, said method being characterized in that it comprises steps consisting in:

copying all the objects contained in said intermediate means of storage that satisfy preset criteria, and

storing, with appropriate indexing, the copies made of said objects in a means of object management associated with said receiving entity.

The intermediate storage means, a proxy cache, for example, will cache all the objects transmitted to the receiving entity, a corporate site, for example, all the objects satisfying preset criteria, all large size objects, for example, that have been transmitted at least once to the site will be stored in the object management means, a Web server, for example. Since this operation makes it possible to bring certain targeted objects closer together, it makes it possible to increase the access speed to the data and allows better selectivity. The contents of the object management means, a Web server, for example, will be set up autonomously as a function of the requests made by the recipient users, for example, the users of a corporate site. The constitution of the content of this Web server generally conforms to the areas of interest of the site, since this is done as a function of the requests from users of this site. Now, an object requested by a user of the site is very likely to interest another user of this site. The use life of the objects contained in this object management means, a Web server, for example, may also be managed autonomously, independent of the particular imperatives specific to the intermediate storage means, a proxy cache, for example.

Advantageously, said step consisting in copying all the objects contained in said intermediate means of storage that will satisfy preset criteria copies only the objects that are bigger than a preset size.

Contrary to what occurs in a cache, the cost of storage is deemed to be less expensive than the cost of organizing the management of the copies. It is therefore not interesting to copy objects of small size, since, on the one hand, these objects can be retrieved relatively quickly from the originating server and, on the other hand, they are difficult to manage because there are too many of them.

According to another aspect of this invention, said step consisting in copying all the objects contained in said intermediate means of storage that will satisfy preset criteria copies only the autonomous objects that are easily reusable as is.

For example, in the case of the Web, files that are not highly autonomous or are difficult to reuse as is such as “.cla” files are not copied.

According to another aspect of this invention, said step consisting in copying all the objects contained in said intermediate means of storage that will satisfy preset criteria copies only the objects that are consistent with the areas of interest associated with the receiving entity.

The consistency of the objects with the areas of interest associated with the receiving entity, a corporate site, for example, can first be measured based on the number of times a given object has been requested in the network. Then, this consistency can be measured using the level of thematic proximity of a given object with respect to total accesses and/or with respect to accesses by means of object management.

According to another aspect of this invention, the method also comprises steps consisting in:

automatically generating files containing links to said objects stored in said object management means, and

storing, with appropriate indexing, said files in said object management means. These type of files, HTML pages, for example, may contain specifications for these objects in addition to the links to the objects.

Advantageously, said step consisting in storing, with appropriate indexing, said files in said object management means automatically classifies said files according to a thematic hierarchy.

Advantageously, said files are accessible by means of a keyword search. According to another aspect of this invention, said step consisting in copying all the objects contained in said intermediate means of storage that satisfy preset criteria copies, at the same time as each object, elements forming a context from which each object is taken, said step consisting in automatically generating files containing links to said objects stored in said object management means associating said elements with the file containing a link to said object.

This type of element forming a context from which an object is taken is, for example, a Web page containing a link with the object and a text description of this object. The file generated will then also be a Web page based on the Web page retrieved. Thus a Web page environment that is thematically consistent with the objects copied is generated.

According to another aspect of this invention, said method comprises a step for managing the use life of the objects contained in said object management means, consisting in eliminating from said object management means an object that does not satisfy preset criteria after a given time interval.

The criteria in question may be the number of accesses to this object, the existence of this object on the originating server or the conformity with the areas of interest of the receiving entity.

Advantageously, said object management means is an HTTP Web server accessible via a standard browser.

Thus, from a user's perspective, everything happens as if the information likely to interest him were available on a single server accessible in the traditional manner, this server being local and thus allowing rapid access to the data.

According to another aspect of this invention, a device for executing a method for reusing information previously received by a receiving entity on the Internet includes a proxy cache, a Web server and an autonomous replication system comprising a desirability analysis stage, an associative reconstitution stage, a content generation stage and a content management stage.

The features of the invention mentioned above along with others will become clearer upon reading the following description of an example of embodiment, said description being given in relation to the sole FIGURE representing a flow chart providing a schematic presentation of the functioning of a device according to this invention and applying a method according to this invention.

In reference to the sole FIGURE a device (1) for reusing information according to an example of embodiment of this invention is applicable to a Web site, a corporate site, for example, designated in the remainder of this description as the receiving site. Of course, the invention could also be adapted to any other Internet access context, for example access through an Internet Service Provider (ISP).

In traditional fashion, a proxy cache (10) is associated with the receiving site. This may, for example, be a Squid proxy cache belonging to the public domain. This type of proxy cache comprises a storage disk (11). It is operated by a control unit (13). Trace files or Log files (12) are also associated with the proxy cache (10). Traditionally, when an HTTP request message to access an object is sent by the receiving site, the proxy cache can return the object directly if it is contained in the cache as the result of a previous identical request. Otherwise, an HTTP request message is sent from the proxy cache to the originating server hosting the URL for transmission of the object to the user. Storage of the objects in the disk (11) is temporary. Each object is stored only for a determined amount of time controlled by an algorithm that is a function, for example, of the input date and the size of the object.

According to the invention, the content of the proxy cache (10) is analyzed to detect the presence of heavy objects and, if necessary, to determine the features of these objects in order to evaluate the desirability of copying them to object management means. By heavy objects we mean objects whose size is bigger than a preset limit size, for example 100 kb. The analysis is performed regularly at an interval that is a function of the average use life of the objects in the proxy cache, in order to copy all the objects satisfying the desirability criteria to a means of object management.

For this purpose, in addition to the proxy cache (10), the device for reusing information (1) comprises an autonomous replication system (20) and an HTTP Web server (30).

The Web server (30) forming the management means is a traditional server, for example an Apache server belonging to the public domain, local to the receiving site. This type of server comprises a storage disk (31) and a control unit (33). This type of server is accessible via a standard browser. The contents of this Web server, as will become clearer in the remainder of this description, consists of pages (32) automatically generated by the system and of heavy objects recopied from the cache onto a disk (31). The autonomous replication system (20) installed in the receiving site comprises four stages, a desirability analysis stage (21), an associative reconstitution stage (22), a content generation stage (23) and a content manager (24).

The function of the desirability analysis stage (21) is to analyze the desirability of making a copy of an object contained on the disk (11) associated with the proxy cache (10) on the disk (31) associated with the Web server (30) forming the management means. To do this, desirability criteria are used. These criteria are applicable after the Log files are crosschecked in order to take into account only the objects effectively present in the cache.

A first desirability criteria applied is the one related to the size of the object. Only large objects, for example bigger than 100 kb, are copied.

A second desirability criteria applied is the one related to the reusability of the object. Objects with little autonomy or that are difficult to reuse as is such as “.cla” files are not copied. Thus, only traditional type objects such as “.mp3,” “.mpg,” “.doc,” “.avi,”, “.jpg,” etc. files are copied.

A third desirability criteria applied is the one related to consistency with the areas of interest of the users of the receiving site. This consistency can first of all be measured by the number of times a given object has been requested in the network; this number is revealed by analyzing the Log files (12). Then, this consistency can be measured by the level of thematic proximity of a given object with respect to total accesses and with respect to accesses to the Web server (30). The levels of thematic proximity are measured in known manner using a semantic analysis engine.

The function of the associative reconstitution stage (22) is to unite the elements forming a context from which the object to be copied is taken. This stage proceeds with the analysis of the Web page in which the link to the object in question is found. The context elements deemed important are retrieved. For example, we can retrieve a Web page containing a link to a compressed file (“.zip”), which makes it possible to have a text description of the object. In certain cases, elements corresponding to a higher level of the hypertext tree are retrieved to obtain a more in-depth description. For example, we can retrieve the page containing a link to the page containing a link to the object. The function of the content generation stage (23) is to make the copy on the disk (31) of the objects selected in stage (21) and, at the same time, to generate a Web page tree structure (32) containing links to the objects copied and describing these copied objects. The Web page tree structure is presented, for example, according to Dewey's formalism. This formalism presents a hierarchical, semantically related theme structure. The pages that correspond to these themes are accessible via links to pages that correspond to other semantically linked themes. Automatically generated pages containing links to the objects copied and the Web pages forming the contextual elements retrieved from the cache in stage (22) are associated with the nodes or leaves of the tree. As described in the document “Distributed Multimedia Document Modeling” by Luigi Lancieri, in “Proceedings of IEEE Joint Conference on Neural Networks,” 1998, a semantic network is used to measure the distance between a Web page forming a contextual element and each node of the tree structure. The Web page with its link to the corresponding object is placed at the tree node for which the semantic distance is the shortest. Every time an object is added to the server, the pages and the links are modified accordingly. The generation of pages can be dynamic for static access or on demand via a GCI (Gateway Common Interface) program or all types of dynamic response formation. Copying the objects between the disk (11) and the cache (10) and the disk (31) of the server (30) involves special processing of the corresponding MIME (Multipurpose Internet Mail Extension) file and, in particular, the elimination of the special header generated by the cache.

From the user's perspective, the interface is similar to what exists for a search engine or a traditional catalogue. The content may also be accessed via keywords. The content viewable by each user may be customized by automatic detection of the profile of each user, as is described in the previously cited document “Distributed Multimedia Document Modeling,” or manually by each user giving keywords characteristic of his profile, or by a combination of both methods.

The copying and storage steps carried out in stages (21, 22 and 23) are performed at a rhythm suited to the average use life of the objects in the cache.

The function of the content management stage (24) is to manage the use life of the objects according to preset terms and conditions. On the one hand, it determines, by sending the corresponding HTTP request message, whether or not an object is still present on the originating server. On the other hand, it measures the number of accesses to the object in question. This number of accesses will serve as the criterion for determining whether or not the object should be eliminated from the Web server (30) forming the management means.

In this system, the disk size is large compared to the systems of the prior art, which gives the objects stored a minimum use life of one to two weeks. An object is eliminated at the end of this time period if it combines several unfavorable factors, for example, it is has never been accessed, if it is no longer on the originating server and if it is not consistent with the areas of interest of the receiving site.

1) Method for reusing information previously received by a receiving entity associated with an intermediate means of storage (10) in a telecommunication network, said intermediate means of storage (10) being suited to temporarily storing information constituting objects transmitted to said receiving entity following successive requests from the receiving entity, characterized by the fact that it comprises steps consisting in: copying all the objects contained in said intermediate storage means (10) that satisfy preset criteria, and storing, with appropriate indexing, the copies made of said objects in an object management means (30) associated with said receiving entity.

2) Method as claimed in claim 1, wherein said step consisting in copying all the objects contained in said intermediate storage means (10) that satisfy preset criteria copies only the objects that are bigger than a preset size.

3) Method as claimed in claim 1 or 2, wherein said step consisting in copying all the objects contained in said intermediate means of storage (10) that satisfy preset criteria copies only the autonomous objects that are easily reusable as is.

4) Method as claimed in any one of the preceding claims, wherein said step consisting in copying all the objects contained in said intermediate means of storage (10) that satisfy preset criteria copies only the objects consistent with the areas of interest associated with said receiving entity.

5) Method as claimed in any one of the preceding claims, characterized in that it also comprises steps consisting in:
automatically generating files (32) containing links to said objects stored in said object management means (30), and
storing, with appropriate indexing, said files in said object management means.

6) Method as claimed in claim 5, wherein said step consisting in storing said files (32) with appropriate indexing in said object management means (30) automatically classifies said files according to a thematic hierarchy.

7) Method as claimed in claim 5 or 6, wherein said files (32) are accessible by mean of a keyword search.

8) Method as claimed in any one of claims 5 through 7, wherein said step consisting in copying all the objects contained in said intermediate means of storage (10) that satisfy preset criteria copies elements forming a context from which said object is taken at the same time it copies each object.

9) Method as claimed in any one of the preceding claims, wherein said method comprises a step for managing the use life of the objects contained in said object management means (30) consisting in eliminating from said object management means an object that, after a given interval of time, does not satisfy preset criteria.

10) Method as claimed in any one of the preceding claims, wherein said object management means (30) is an HTTP Web server accessible via a standard browser.

11) Device for executing a method for reusing information previously received by a receiving entity on the Internet as claimed in any one of the preceding claims, wherein said device (1) comprises a proxy cache (10), a Web server (30) and an autonomous replication system (20) comprising a desirability analysis stage (21), an associative reconstitution stage (22), a content generation stage (23) and a content management stage (24).

12) Autonomous replication device (20) intended to be associated with a proxy cache (10) and a Web server (30) to execute a method for reusing information previously received by a receiving entity on the Internet as claimed in any of claims 1 through 10, said device (20) being characterized in that it comprises a desirability analysis stage (21), an associative reconstitution stage (22), a content generation stage (23) and a content management stage (24).
